(19) United States
(12) Patent Application Publication
(10) Pub. No.: US 2016/0155567 A1
(43) Pub. Date: Jun. 2, 2016

(54) MANUFACTURING METHOD OF SPLIT TYPE AND INCOMPLETE SPLIT TYPE NON-MAGNETIZED PERMANENT MAGNETS AND INCOMPLETE SPLIT TYPE NON-MAGNETIZED PERMANENT MAGNET

(71) Applicant: HYUNDAI MOTOR COMPANY, Seoul (KR)

(72) Inventors: Jung Shik KIM, Seoul (KR); Sang Hoon MOON, Yongin-si (KR); Kyoung Bum KIM, Yongin-si (KR); Kun Min PARK, Suwon-si (KR); Hyoung Jun CHO, Seoul (KR)

(21) Appl. No.: 14/709,401

(22) Filed: May 11, 2015

(30) Foreign Application Priority Data
Dec. 2, 2014 (KR) 10-2014-0170783

(51) Int. Cl. H01F 41/02

(52) U.S. Cl. CPC H01F 41/0253

(57) ABSTRACT

A manufacturing method of split type non-magnetized permanent magnet may include manufacturing an anisotropic block having a uniformly aligned magnetization determining direction. A first cutting operation of cutting the anisotropic block in a direction which is perpendicular to the magnetization determining direction is performed. A grain boundary diffusion is performed on the plurality of slit blocks. Adhering surfaces of the plurality of split blocks to each other which are cut by the first cutting operation is performed. A second cutting operation of cutting the block in a direction is performed which is perpendicular to the magnetization determining direction and the first cutting direction.

### CROSS REFERENCE TO RELATED APPLICATION

The present application claims priority to Korean Patent Application No. 10-2014-0170783, filed on Dec. 2, 2014 in the Korean Intellectual Property Office, the entire contents of which is incorporated herein in its entirety by reference.

### BACKGROUND

1. Technical Field

The present disclosure relates to a manufacturing method of split type and incomplete split type non-magnetized permanent magnets and an incomplete split type non-magnetized permanent magnet, and more particularly, to a manufacturing method of split type and incomplete split type non-magnetized permanent magnets and an incomplete split type non-magnetized permanent magnet capable of reducing eddy current loss.

2. Description of the Related Art

Conventionally, as a driving source of an electric vehicle or an electric rail car, a permanent magnet motor has been used. As one example of a structure thereof, the permanent magnet motor may include a stator having a coil installed thereon and a rotor connected to a driving shaft and having a permanent magnet installed thereon. The motor may be rotated by supplying an alternating current to the rotor and alternately changing polarity.

However, when the motor is rotated and driven, a large eddy current is generated in the permanent magnet while strong magnetic flux generated by the coil penetrates through the permanent magnet, and heat is generated in the permanent magnet by the generated eddy current, thereby increasing loss of electricity.

As a countermeasure, a plurality of permanent magnet pieces obtained by splitting and insulating a permanent magnet base material are combined and the generated eddy current is constrained in each permanent magnet piece, such that an amount of eddy current generated in the permanent magnet may be reduced.

As shown in FIGS. 1 and 2, eddy current loss is proportional to each size of the permanent magnet. Therefore, there is a need for a technology capable of manufacturing a higher efficiency motor by massively producing a split type permanent magnet.

Further, a grain boundary diffusion technology for further increasing a magnetic property of the permanent magnet has been developed. However, as shown in FIGS. 3 and 4, a manufacturing method of a non-magnetized permanent magnet using grain boundary diffusion according to the related art may not be massively produced the non-magnetized permanent magnet. FIG. 3 is a diagram illustrating processes of manufacturing a permanent magnet block 1 (S310), dividing and re-adhering the block 1 (S320), cutting the block 1 into a size of a finished product (S330), and then performing a grain boundary diffusion (S340). The above-mentioned processes lose adhesive property because an adhesive adhering the split block is deteriorated by a heating for increasing diffusion property of the block at the time of performing the grain boundary diffusion. FIG. 4 shows a method of manufacturing a permanent magnet block 1 (S410), cutting the block 1 into a final size (S420), performing a grain boundary diffusion (S430), and splitting and adhering a piece (S440). However, since splitting all pieces and then adhering all pieces geometrically increases processing time, it is difficult to perform mass production.

Therefore, a new manufacturing method of a permanent magnet capable of applying all of the grain boundary diffusion, the splitting, and the adhering has been demanded.

### SUMMARY

An object of the present disclosure is to provide a manufacturing method of split type and incomplete split type non-magnetized permanent magnets and an incomplete split type non-magnetized permanent magnet capable of applying a grain boundary diffusion while reducing eddy current loss.

According to an exemplary embodiment of the present disclosure, there is provided a manufacturing method of a split type non-magnetized permanent magnet including: manufacturing an anisotropic block having a uniformly aligned magnetization determining direction; performing a first cutting operation by cutting the anisotropic block in a first cutting direction perpendicular to the magnetization determining direction so as to form a plurality of split blocks; performing a grain boundary diffusion on the plurality of split blocks; after performing the grain boundary diffusion, forming an adhered block by adhering surfaces of the plurality of split blocks to each other which are cut by the first cutting operation; and performing a second cutting operation by cutting the adhered block in a second direction perpendicular to the magnetization determining direction and the first cutting direction.

In the manufacturing of the block, the block may be press-molded under an environment in which a magnetic field having a predetermined direction is formed and a thickness of the block in the magnetization determining direction may be 7 mm or less.

In the second cutting operation, the block may be cut so as to have a width of 15 mm or more.

According to another exemplary embodiment of the present disclosure, there is provided a manufacturing method of an incomplete split type non-magnetized permanent magnet including: manufacturing an anisotropic block having a magnetization determining direction which is uniformly aligned; wire-cutting 90% or less of a thickness of the anisotropic block in a first wire-cutting direction which is parallel to the magnetization determining direction; cutting the block in a second cutting direction which is perpendicular to the magnetization determining direction so as to form a plurality of split blocks; and performing a grain boundary diffusion on the plurality of split blocks.

In the cutting of the block, the block may be cut so as to have a width of 7 mm or less in the magnetization determining direction.

In the wire-cutting of the block and the cutting of the block, the block may be cut so that a non-cutting portion that is formed to extend in a direction perpendicular to a wire-cutting direction and a cutting portion that is formed to extend in a direction (perpendicular to the wire-cutting direction and a cutting direction from the non-cutting portion are able to be configured.

According to another exemplary embodiment of the present disclosure, there is provided an incomplete split type non-magnetized permanent magnet including a block having an aligned magnetization determining direction. The block has a gap formed in a direction perpendicular to the magnetization determining direction and includes a non-cutting portion which is not split by the gap and a cutting portion formed to be extended in a direction of the gap from the non-cutting portion.

### BRIEF DESCRIPTION OF THE DRAWINGS

The above and other objects, features and advantages of the present disclosure will be more clearly understood from the following detailed description taken in conjunction with the accompanying drawings.

FIG. 1 is a diagram showing a flow of an eddy current generated in a permanent magnet.

FIG. 2 is a graph comparing magnitude of the eddy current generated depending on a size of the permanent magnet.

FIG. 3 is a diagram showing processes of performing a grain boundary diffusion after a splitting and an adhering according to the related art.

FIG. 4 is a diagram showing processes of a splitting and an adhering after performing a grain boundary diffusion according to the related art.

FIG. 5 is a diagram showing processes according to an exemplary embodiment of a manufacturing method of a split type non-magnetized permanent magnet.

FIG. 6 is a diagram showing processes according to an exemplary embodiment of a manufacturing method of an incomplete split type non-magnetized permanent magnet.

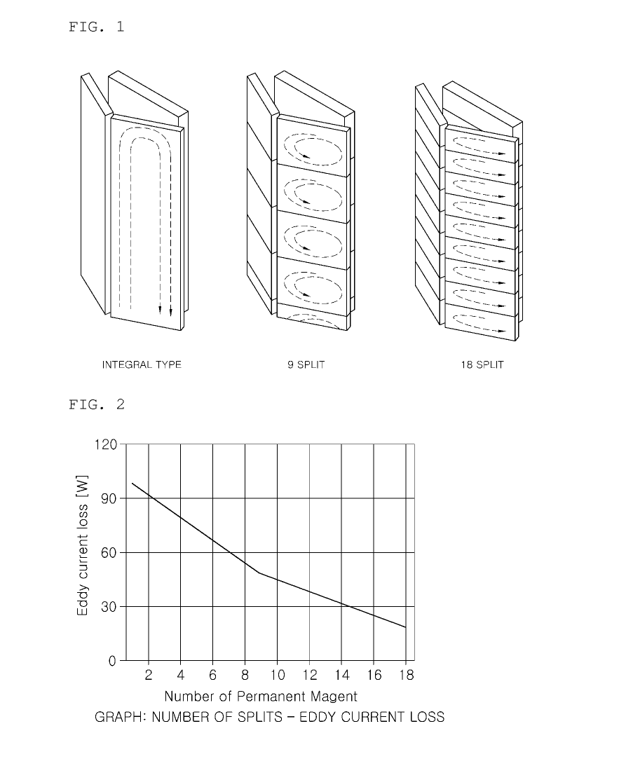

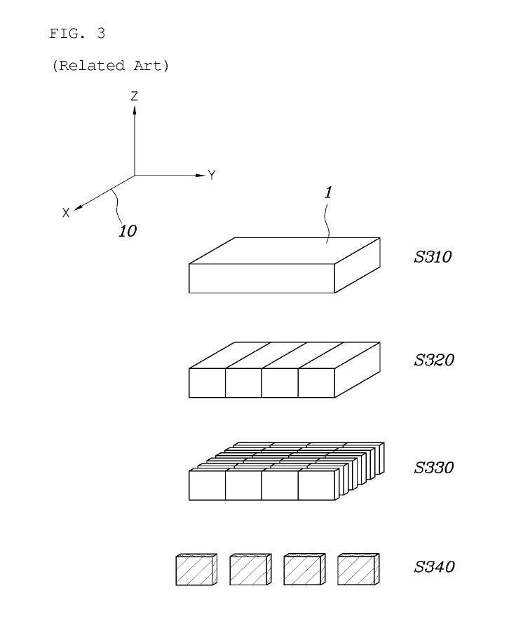

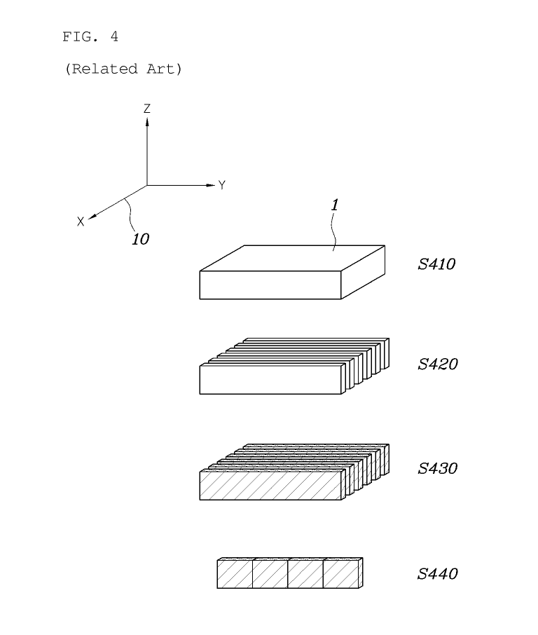

### DETAILED DESCRIPTION

Special terms used in the present specification are used only in order to describe specific exemplary embodiments rather than limiting the present disclosure. Singular forms used herein are intended to include plural forms unless explicitly indicated otherwise. It will be further understood that the terms “comprises” used in this specification, specify stated features, regions, integers, steps, operations, components, and/or parts, but do not preclude the presence or addition of other stated features, regions, integers, steps, operations, components, and/or parts.

Unless indicated otherwise, it is to be understood that all the terms used in the specification including technical and scientific terms have the same meaning as those that are understood by those who skilled in the art. It must be understood that the terms defined by the dictionary are identical with the meanings within the context of the related art, and they should not be ideally or excessively formally defined unless the context clearly dictates otherwise.

Hereinafter, a manufacturing method of split type and incomplete split type non-magnetized permanent magnet and an incomplete split type non-magnetized permanent magnet according to exemplary embodiments of the present disclosure will be described with reference to the accompanying drawings.

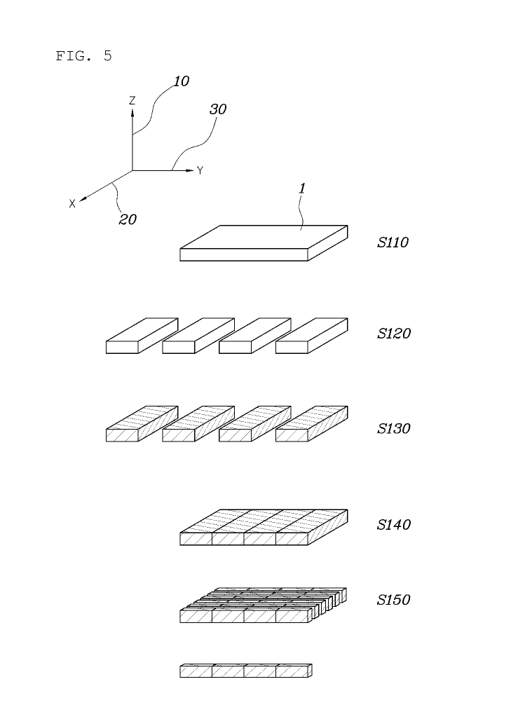

As shown in FIG. 5, a manufacturing method of a split type non-magnetized permanent magnet includes manufacturing an anisotropic block 1 having a magnetization determining direction 10 which is uniformly aligned (S110), a first cutting operation (S120) of cutting the block 1 in a first cutting direction 20 which is perpendicular to the magnetization determining direction 10, performing a grain boundary diffusion for a split block 1 (S130), re-adhering surfaces (S140)which are cut by the first cutting operation (S120), and a second cutting operation (S150) of cutting the block 1 in a second cutting direction 30 which is perpendicular to the magnetization determining direction 10 and the first cutting direction 20 in the first cutting operation (S120).

Due to characteristics of the process in which the grain boundary diffusion needs to be performed along the magnetization determining direction 10, a thickness of the magnetization determining direction 10 of the block 1 needs to be thinly cut so that particles are easily diffused. Although the thickness is conventionally controlled while cutting the block 1 in a direction perpendicular to the magnetization determining direction 10 after the block 1 is manufactured, in the present embodiment the thickness of the magnetization determining direction 10 may be molded to be thin in a process of manufacturing the block 1. The manufactured block 1 is cut in the first cutting direction 20 perpendicular to the magnetization determining direction 10 and the grain boundary diffusion is then performed for the manufactured block 1. In this case, since the adhesion is not performed before the grain boundary diffusion, it is possible to prevent deterioration loss of an adhesive. Once the grain boundary diffusion is completed, the cut surfaces of the block 1 are re-adhered to each other. As an example of the adhesive used for the re-adhesion, a general epoxy based adhesive may be used. The split type non-magnetized permanent magnet may be finished by cutting the adhered block 1 in the second cutting direction 30 which is perpendicular to both the magnetization determining direction 10 and the first cutting direction 20.

In the manufacturing of the block (S110), the block 1 is press-molded under an environment in which a magnetic field having a predetermined direction is formed and the thickness of the block 1 in the magnetization determining direction 10 is preferably manufactured to be 7 mm or less.

The reason that properties of a surface and an inner portion of the block 1 are different from each other is because the grain boundary diffusion is not sufficiently performed up to a central portion of the block 1 when the thickness exceeds 7 mm.

In the cutting operation (S150), the block is preferably cut to have a width of 15 mm or more.

The non-magnetized permanent magnet manufactured according to the present disclosure is generally installed in other parts such as a motor, and the like. In this case, once a size of the block 1 is a predetermined size or less, since it is difficult to assemble the parts to thereby cause deterioration in productivity, a length of an x axis direction is limited to 15 mm in the present disclosure.

In the performing of the grain boundary diffusion (S130), dysprosium and terbium are applied to the surface perpendicular to the magnetization determining direction 10 of the block 1 so as to be diffused into the block 1. It is preferable to increase diffusion by heating the block 1 to 600° C. and cool the block 1 to room temperature upon the termination of the diffusion. Since the manufacturing method of the permanent magnet using the grain boundary diffusion as described above is a known technology as described in a background technology of the present disclosure, a more detail description thereof will be omitted.

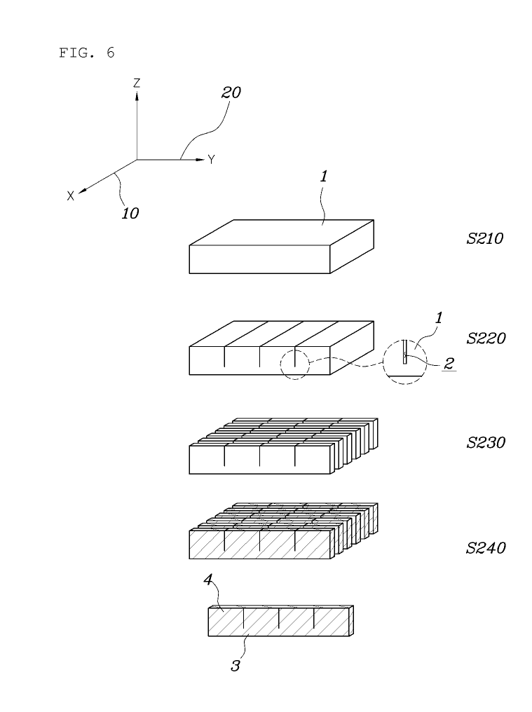

As shown in FIG. 6, a manufacturing method of an incomplete split type non-magnetized permanent magnet includes manufacturing an anisotropic block 1 having a magnetization determining direction 10 which is uniformly aligned (S210), wire-cutting 90% or less of a thickness of the block 1 in a direction 10 which is parallel to the magnetization determining direction 10 (S220), cutting the block 1 in a direction 20 which is perpendicular to the magnetization determining direction 10 (S230), and performing a grain boundary diffusion for the split blocks 1 (S240).

Unlike the foregoing manufacturing method of the split type non-magnetized permanent magnet, the anisotropic block 1 in the manufacturing method of the incomplete split type non-magnetized permanent magnet does not need to form the thickness of the magnetization determining direction 10 to be thin in the manufacturing of the block 1 (S210). The reason is that there is the cutting of the block 1 (S230) into a surface perpendicular to the magnetization determining direction 10 similar to the related art. A difference between the present disclosure and the related art is that when the block 1 is cut so as to be parallel to the magnetization determining direction 10, the block 1 is not completely cut and is maintained in a state in which a portion thereof is connected. In this case, with consideration for low strength of the block 1, the block 1 is cut using wire-cutting in order to prevent the block 1 from being damaged by impact or vibration. Once the cut thickness of the block 1 is limited to 90% or less of the overall thickness, eddy current loss may be reduced while maintaining minimum connection strength. In addition, the adhesive that serves as a shielding material and a reinforcing material is inserted into a gap 2 which is cut by the wire-cutting. As an example of the adhesive, a general epoxy based adhesive may be used.

In the cutting of the block 1 (S230), the block 1 is preferably cut to have a width of 7 mm or less. As described in the description of the manufacturing method of the split type non-magnetized permanent magnet, the reason that properties of a surface and an inner portion of the block 1 are different from each other is because the grain boundary diffusion is not sufficiently performed up to a central portion of the block 1 when the thickness exceeds 7 mm.

In the wire-cutting of the block (S220) and the cutting of the block (S230), the block is preferably cut so that a non-cutting portion that is formed to extend in a direction (y axis direction) perpendicular to a wire-cutting direction and a cutting portion that is formed to extend in a direction (z axis direction) perpendicular to the wire-cutting direction and the cutting direction from the non-cutting portion may be configured.

The block 1 that is formed by the above-mentioned incomplete cutting is formed in a shape such as a plate having a crack formed in a portion thereof. The grain boundary diffusion may easily occur by matching the magnetization determining direction and the thin thickness direction and eddy current loss may be reduced by cutting a portion of the surface perpendicular to the magnetization determining direction to decrease an area in which an eddy current may occur.

As shown in FIG. 6, an incomplete split type non-magnetized permanent magnet includes a block 1 having an aligned magnetization determining direction. The block 1 has a gap 2 formed in a direction perpendicular to the magnetization determining direction and includes a non-cutting portion 3 which is not split by the gap 2 and a cutting portion 4 formed to be extended in a direction of the gap 2 from the non-cutting portion 3.

A detailed description thereof will be substituted with the description of the foregoing manufacturing method.

According to the exemplary embodiments of the present disclosure, the manufacturing method of split type and incomplete split type non-magnetized permanent magnets and the incomplete split type non-magnetized permanent magnet may have the following effects.

First, eddy current loss is reduced, thereby making it possible to increase efficiency of the motor.

Second, since the manufacturing method is efficient, the present disclosure may be suitable for mass production.

Although the exemplary embodiments of the present disclosure have been described with reference to the accompanying drawings, those skilled in the art will appreciate that various modifications and alterations may be made without departing from the spirit or essential feature of the present disclosure.

Therefore, it should be understood that the exemplary embodiments described above are not restrictive, but are exemplary in all aspects. It should be interpreted that the scope of the present disclosure is defined by the following claims rather than the above-mentioned detailed description and all modifications or alterations deduced from the meaning, the scope, and equivalences of the claims are included in the scope of the present disclosure.

What is claimed is:

1. A manufacturing method of a split type non-magnetized permanent magnet, the method comprising:
manufacturing an anisotropic block having a uniformly aligned magnetization determining direction;
performing a first cutting operation by cutting the anisotropic block in a first cutting direction perpendicular to the magnetization determining direction so as to form a plurality of split blocks;
performing a grain boundary diffusion on the plurality of split blocks;
after performing the grain boundary diffusion, forming an adhered block by adhering surfaces of the plurality of split blocks to each other which are cut by the first cutting operation; and
performing a second cutting operation by cutting the adhered block in a second direction perpendicular to the magnetization determining direction and the first cutting direction.

2. The manufacturing method of claim 1, wherein in the manufacturing of the block, the block is press-molded under an environment in which a magnetic field having a predetermined direction is formed, and a thickness of the anisotropic block in the magnetization determining direction is 7 mm or less.

3. The manufacturing method of claim 2, wherein in the second cutting operation, the block is cut so as to have a width of 15 mm or more.

4. A manufacturing method of an incomplete split type non-magnetized permanent magnet, the method comprising:
manufacturing an anisotropic block having a magnetization determining direction which is uniformly aligned;
wire-cutting 90% or less of a thickness of the anisotropic block in a first wire-cutting direction which is parallel to the magnetization determining direction;
cutting the block in a second cutting direction perpendicular to the magnetization determining direction so as to form a plurality of split blocks; and
performing a grain boundary diffusion on the plurality of split blocks.

5. The manufacturing method of claim 4, wherein in the cutting of the block, the block is cut so as to have a width of 7 mm or less in the magnetization determining direction.

6. The manufacturing method of claim 5, wherein in the wire cutting of the block and the cutting of the block, the block is cut so that a non-cutting portion that is formed to extend in the second cutting direction perpendicular to the first wire-cutting direction and a cutting portion that is formed to extend in a direction perpendicular to the first wire-cutting direction and the second cutting direction from the non-cutting portion are able to be configured.

7. An incomplete split type non-magnetized permanent magnet, comprising:
a block having an aligned magnetization determining direction,
wherein the block has a gap formed in a direction perpendicular to the magnetization determining direction and includes a non-cutting portion which is not split by the gap and a cutting portion formed to extend in a direction of the gap from the non-cutting portion.
